(19) United States
(12) Patent Application Publication
(10) Pub. No.: US 2023/0397533 A1
(43) Pub. Date: Dec. 14, 2023

(54) COMBINE HARVESTER WITH DRIVER ASSISTANCE SYSTEM

(71) Applicant: CLAAS Selbstfahrende Erntemaschinen GmbH, Harsewinkel (DE)

(72) Inventors: Martin Iseringhausen, Harsewinkel (DE); Joachim Baumgarten, Beelen (DE); Matthias Gausmann, Osnabrück (DE); Robert Bühlmeier, Herzebrock-Clarholz (DE); Patrick Schulze Vohren, Sassenberg (DE); Sascha Dieckmeyer, MeIle (DE); Maximilian Schröder, Gütersloh (DE)

(73) Assignee: CLAAS Selbstfahrende Erntemaschinen GmbH, Harsewinkel (DE)

(21) Appl. No.: 18/207,449

(22) Filed: Jun. 8, 2023

(30) Foreign Application Priority Data
Jun. 9, 2022 (DE) 10 2022 114 529.8

(51) Int. Cl. A01D 41/127

(52) U.S. Cl. CPC A01D 41/1273; A01D 41/1276

(57) ABSTRACT

A combine harvester having a plurality of working units for performing a harvested material processing operation is disclosed. The plurality of working units comprise at least one separator and one cleaning device. A grain loss sensor may be present in one or both of the separator or the cleaning device. The combine harvester comprises a driver assistance system, which comprises a grain loss sensor setting assistant configured to determine and to set the grain loss sensor sensitivity of the grain loss sensor(s) of the separator and/or the cleaning device. The grain loss sensor setting assistant may determine in a dialog with an operator the grain loss sensor sensitivity to be set for the grain loss sensor(s).

### CROSS REFERENCE TO RELATED APPLICATION

This application claims priority under 35 U.S.C. § 119 to German Patent Application No. DE 102022 114 529.8 filed Jun. 9, 2023, the entire disclosure of which is hereby incorporated by reference herein.

### TECHNICAL FIELD

The present application relates to a combine harvester, a driver assistance system for use in a combine harvester, and a method for determining and adjusting a grain loss sensor sensitivity of at least one grain loss sensor of a combine harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Combine harvesters (interchangeably termed combines) are machines designed to harvest a variety of crops. The combine harvesters may perform one or more harvesting operations, such as any one, any combination, or all of reaping, threshing, gathering and winnowing. An example combine harvester is disclosed in US Published Application No. 2021/0084816 A1, incorporated by reference herein in its entirety.

In the harvesting mode of a combine harvester, grain losses are those grains of the flow of harvested material which are picked up or collected that were either not effectively threshed out of the straw or, despite being threshed out by the threshing device (also known as the threshing unit), or by the cleaning device of the combine harvester, were not conveyed further into the grain tank (as actually desired), but, like the threshed straw, are left behind by the combine harvester on the field. These grain losses, which should be kept as low as possible, may depend on the one hand on the travel speed and the operating settings (especially of the threshing device of the combine harvester), and on the other hand on environmental conditions such as the nature of the harvested material and the field (e.g., with respect to moisture and crop density).

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 shows a schematic and exemplary representation of a combine harvester;

FIG. 2 shows a schematic and exemplary representation of a grain loss sensor setting assistant; and

FIG. 3 shows a schematic and exemplary representation of a dialog step of a dialog of the grain loss sensor setting assistant.

### DETAILED DESCRIPTION

As discussed in the background, grain losses may be those grains that were not effectively threshed out of the straw or despite being threshed out by the threshing device, were not conveyed into the grain tank. The grain losses may depend on travel speed/operating settings and environmental conditions. There may therefore be no invariable and optimal settings for the threshing device for all boundary conditions; instead, these settings typically must be adjusted to reduce or minimize grain losses according to the above environmental conditions and travel speed.

At the same time, there may be regular economic specifications regarding maximum grain loss that should not be exceeded when harvesting an agricultural area or a field and which may be specified as a proportion of the total grains or by another metric. In this context, it may often be economically sensible or required to simultaneously minimize the harvesting time, which may be possible, for example, by increasing the driving speed, or to reduce the energy consumption of the threshing device while observing the maximum grain loss, wherein these two specifications may conflict with one another (e.g., a conflict of objectives) with regard to grain losses. The combine harvester driver therefore may routinely strive to operate the combine harvester just below the specified grain loss limit.

In this context, the determination of the current grain losses during the harvesting process, which may be important for such an adjustment, has so far proven to be difficult. On the one hand, the driver of the combine harvester or an assistant in the field between the straw and chaff left behind by the combine harvester may qualitatively record the density or quantity of the loss grain also left behind. Clearly, this method is both cumbersome and inaccurate, and adjusting the settings of the combine harvester by re-measuring is particularly time-consuming. The use of a grain loss pan to collect loss grains, which are either placed by the combine harvester at specific times or manually placed by an assistant to collect the loss grain, may only represent a slight improvement of this principle. A grain loss pan is disclosed in DE 198 20 819 C2.

Grain loss sensors may be arranged or positioned on the combine harvester. For example, the grain loss sensors may be arranged or positioned in the vicinity of (or proximate to) a straw walker or a separator rotor of a separator of the combine harvester and may be intended to determine the grain losses on the basis of the detected impact behavior of falling grains. A grain loss sensor is disclosed in EP 0 339 142 Bi.

In one or some embodiments, grain losses may mean either an absolute amount of grain losses (e.g., expressed in grain volume or grain mass per unit field area) or a relative amount related to another quantity.

One problem with grain loss sensors is that it may be difficult to establish a relationship between the values measured by the grain loss sensor and the actual grain losses. This may be because the relationship between the values measured by the grain loss sensor (which may be referred to here and below as the sensor values of the grain loss sensor and designate the measurement signal generated by the grain loss sensor as such) and the actual grain losses may also depend very strongly on the total volume of harvested material flow and the above-mentioned environmental conditions. A so-called calibration of the grain loss sensors (e.g., a determination and setting of a grain loss sensor sensitivity) may therefore be necessary in order to establish the previously mentioned relationship between the values measured by the grain loss sensor and the actual grain losses, which may be determined, for example, via the previously mentioned grain loss pan. However, performing such a calibration may be very time-consuming.

Accordingly, it may be an object to provide a combine harvester that enables extremely simple but precise determination and setting of grain loss sensor sensitivity of a grain loss sensor, that is, extremely simple and precise calibration of a grain loss sensor, whereby the efficiency of a harvested material processing operation may be increased.

Accordingly, in one or some embodiments, a combine harvester is disclosed that has a plurality of working units configured to perform one or more harvested material processing operations. In one or some embodiments, the plurality of working units may comprise at least one separating device and at least one cleaning device. The separating device may comprise at least one grain loss sensor, and/or the cleaning device may comprise at least one grain loss sensor. In this regard, one or both of the at least one separator or the at least one cleaning device may comprise at least one grain loss sensor. The combine harvester may further comprise a driver assistance system, which may include a memory configured to store data and/or parameters, a computing device configured to process the data and/or parameters that may be stored in the memory, and an input/output unit (e.g., a touchscreen). The driver assistance system may further comprise a grain loss sensor setting assistant configured to determine and/or set a grain loss sensor sensitivity of the at least one grain loss sensor of the separator and/or the at least one grain loss sensor of the cleaning device (e.g., determine and adjust the grain loss sensor sensitivity of the at least one grain loss sensor of one or both of the at least one separator or the at least one cleaning device). The grain loss sensor setting assistant may determine, in a dialog with an operator in one or more dialog steps, the grain loss sensor sensitivity to be set for the at least one grain loss sensor of the separator and/or the at least one grain loss sensor of the cleaning device.

In one or some embodiments, the dialog-based procedure using the grain loss sensor setting assistant may allow particularly easy and supported but very precise determination and setting of the grain loss sensor sensitivity. Specifically, the combine harvester operator may be guided step-by-step to the recommended setting for the grain loss sensor sensitivity. The operator does not need to personally know which data or parameters are used to determine the grain loss sensor sensitivity. In addition, the operator does not need to know the specific relationships between these data or parameters that are necessary for determining the grain loss sensor sensitivity.

Furthermore, if the operator has the grain loss sensor sensitivity that is to be set, he does not have to set it himself/herself in a time-consuming manner. Instead, it may be automatically adopted or set within the scope of the dialog-based procedure according to the previously determined grain loss sensor sensitivity. This may ensure a particularly uncomplicated and error-free, yet highly precise, calibration of the grain loss sensors, which may increase the efficiency of a harvested material processing operation to be performed by the combine harvester.

Another advantage may be that the operator of the combine harvester is involved in the determination and adjustment process through the dialog-based procedure. This may allow the operator, whether he/she is an inexperienced operator or an experienced operator, to gather important empirical values that may enable him/her to make adjustments to the working parameters and machine settings in future harvested material processing operations.

In one or some embodiments, the grain loss sensor setting assistant is configured to determine the grain loss sensor sensitivity in the dialog taking into account retrievable and/or presettable data or parameters relating to the combine harvester and/or a harvested material processing operation. This may ensure that some or all data and/or parameters required and/or necessary for determining the grain loss sensor sensitivity are taken into account, but only those data or parameters relating to the combine harvester and/or a harvested material processing operation need to be entered by the operator that are not already available to the driver assistance system. The dialog of the grain loss sensor setting assistant therefore may ensure that the operator only has to make necessary settings or only has to transfer necessary data or parameters and/or may accept settings suggested by the system directly (e.g., without further input), such as confirm them.

In one or some embodiments, the dialog of the grain loss sensor setting assistant comprises a dialog step A in which the grain loss sensor setting assistant is configured to check whether operating states of the combine harvester required for determining and setting the grain loss sensor sensitivity are present. For example, the grain loss sensor setting assistant may check whether the combine harvester is operating in one or more predetermined operating states (which are conducive for determining and setting the grain loss sensor sensitivity, such as a predetermined operating state of the combine harvester).

In one or some embodiments, in dialog step A, the grain loss sensor setting assistant is configured to check whether the combine harvester is in a harvested material processing operation and/or the harvester material processing operation is being performed by the combine harvester under stationary conditions.

In one or some embodiments, in dialog step A, responsive to the grain loss sensor setting assistant determining that the combine harvester is not in a harvested material processing operation and/or the harvested material processing operation by the combine harvester is not under stationary conditions, the grain loss sensor setting assistant is configured to generate an instruction to the operator receives to control the combine harvester.

This may ensure that the determination and setting of the grain loss sensor sensitivity of the grain loss sensors (e.g., the calibration of the grain loss sensors) is also really only performed when the operating conditions required or necessary for this are actually present. A grain loss sensor sensitivity may therefore be determined and set that leads to an efficient harvested material processing operation. The generation of inaccurate or unrealistic parameter sets for the calibration of the grain loss sensors may therefore be avoided.

In one or some embodiments, the dialog of the grain loss sensor setting assistant comprises a dialog step B, in which the operator may enter any one, any combination, or all of: a grain loss target to be achieved during a harvested material processing operation; a working width of an attachment mounted on the combine harvester; or a yield of the combine harvester.

The input of a desired grain loss target and optionally the working width of the attachment by the operator may create data or parameters for the determination of the sensor sensitivity, such as for the determination of actual grain losses, which may be performed in an initial (e.g., first-time) calibration process during a harvested material processing operation.

In one or some embodiments, the dialog of the grain loss sensor setting assistant comprises a dialog step C, in which the operator enters one or both of dimensions of a grain loss pan or a placement position of the grain loss pan. This may provide additional data or parameters that may be used to determine actual grain losses.

In one or some embodiments, the dialog of the grain loss sensor setting assistant comprises a dialog step D in which the operator receives an instruction to initiate a placement of the grain loss pan.

In one or some embodiments, in dialog step D, the operator may trigger or initiate any one or both of the following: a measurement for determining grain losses of the separator and/or the cleaning device; or a measurement for determining a yield of the combine harvester. Various sensor values may be determined (e.g., determined over a specified measuring period), such as any one, any combination, or all of: a sensor value of the at least one grain loss sensor of the separator; a sensor value of the at least one grain loss sensor of the cleaning device; or a sensor value of a sensor for determining the yield of the combine harvester.

In one or some embodiments, in dialog step D, the grain loss sensor setting assistant may generate an instruction to the operator to: trigger the measurement for determining grain losses of the separator and/or the cleaning device; and/or trigger the measurement for determining the yield of the combine harvester basically at the same time as the grain loss pan is deposited.

This may generate additional data and/or parameters that may be relevant to determining grain loss sensor sensitivity. Furthermore, it may ensure that the sensors detect essentially the same portion of the crop mixture that is also collected by the grain loss pan. Therefore, a correlation may be created between the sensor values from the various sensors and actual grain losses from the grain loss pan.

In one or some embodiments, the dialog of the grain loss sensor setting assistant comprises a dialog step E, in which the grain loss sensor setting assistant generates an output so that the operator may select a metric for inputting an amount of loss grains determined using the grain loss pan, so that the operator inputs the determined amount of loss grains, and so that the actual grain losses are displayed to the operator.

In one or some embodiments, the dialog of the grain loss sensor setting assistant comprises a dialog step F in which the determined grain loss sensor sensitivity for the at least one grain loss sensor of the separator and/or for the at least one grain loss sensor of the cleaning device is displayed to the operator, and, in turn, the operator may adjust the grain loss sensor sensitivity displayed to him/her.

In one or some embodiments, the dialog of the grain loss sensor setting assistant comprises a dialog step G in which the operator confirms the grain loss sensor sensitivity displayed to him/her and may be adjusted, whereby the grain loss sensor sensitivity for the at least one grain loss sensor of the separator and/or for the at least one grain loss sensor of the cleaning device may be adjusted or rejected.

The operator therefore may receive information about which grain loss sensor sensitivity is recommended to be set, but also has the option of changing or manipulating this according to the operator's wishes and experience. By simply confirming the recommendation, this may be immediately adopted for the corresponding grain loss sensor.

Furthermore, a method for determining and adjusting a grain loss sensor sensitivity of at least one grain loss sensor of such a combine harvester may be performed using any of the steps discussed above.

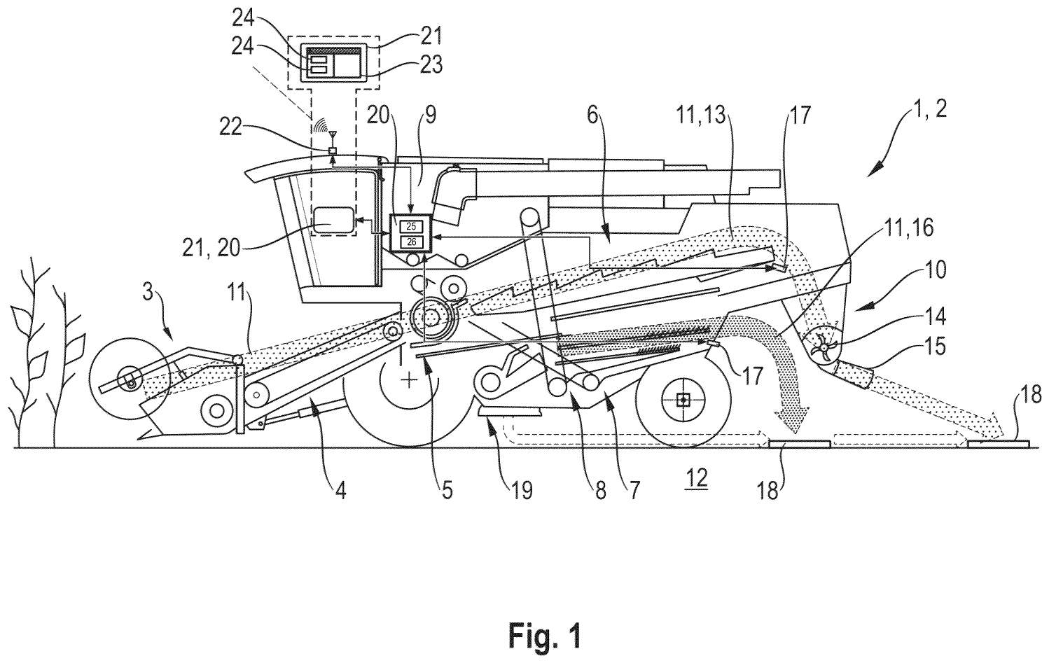

Referring to the figures, FIG. 1 depicts a harvester 1 designed as a combine harvester 2 in a schematic and exemplary representation. The combine harvester 2 has an attachment 3 attached or adapted to the combine harvester 2 as any one, any combination, or all of a cutting unit, an inclined conveyor 4, a threshing device 5 (also referred to as a threshing unit), a separator 6, a cleaning device 7, a transport device 8, a grain tank 9 and a distributing device 10, all of which are also referred to as working units of the combine harvester 2 for performing harvested material processing operation(s). In one or some embodiments, a flow of harvested material 11, which comprises grain components and non-grain components such as chaff and straw, received by the attachment 3 during a harvested material processing operation is conveyed through and processed in a process by these working units of the combine harvester 2 substantially in the mentioned order.

More specifically, in the threshing device 5 and the separator 6, the grain components are to be separated from the non-grain components (e.g., the harvested material for that matter), wherein the separated grain components undergo cleaning from the non-grain components in the cleaning device 7, and subsequently the cleaned grain components are fed to the grain tank 9 using the transport device 8. The non-grain components, such as the straw and the chaff, may then be deposited at the rear of the combine harvester 2 by the spreading device 10 on the ground or agricultural area 12 being worked by the combine harvester, or emerge from the combine harvester 2 at the corresponding end of the separator 6, which may comprise longitudinally oriented straw walkers or separator rotors, and pass onto the ground or agricultural area 12.

In the threshing device 5, most of the grain components may be separated from the received flow of harvested material 11. The so-called residual grain and the non-grain components pass to the separator 6 where another separation process takes place to separate most of the residual grain from the non-grain components in the flow of harvested material 11. The harvested material mixture 13 of non-separated residual grain and non-grain components emerging from the end of the separator 6 may be returned to the ground or agricultural area 12 by the distributing device 10, which may comprise a straw chopper 14, such as a power spreader 15.

The grain components obtained from the threshing device 5 and the separator 6 may be fed to the cleaning device 7 in a next step. In this process, further non-grain components may be blown away by the combination of sieves and directed air streams. The transport device 8, comprising or consisting of screw conveyors and elevators, may convey the now cleaned grain constituents to the grain tank 9. From there, they are then transferred to a removal truck.

Depending on various factors, such as, for example, any one, any combination, or all of travel speed, crop density, or moisture, grain losses may occur during this harvested material processing operation, which is also known as a combine threshing process. This may occur in any one, any combination, or all of the following: during intake; threshing in the threshing device 5; during separation in the separator 6; in the cleaning device 7. The reference sign 16 denotes harvested material losses or grain losses that may occur during the cleaning process. Further harvested material losses 16 may result from the separation process by the separator 6.

To determine the harvested material losses 16, at least one grain loss sensor 17 may be used, which may serve to detect the grain components emerging from the combine harvester as harvested material losses 16. In one or some embodiments, at least two grain loss sensors 17 are used, the positioning of which may be performed in a known manner at the end of the separator 6 and the cleaning device 7 (e.g., in the delivery area of the flow of harvested material 11 comprising or consisting essentially of non-grain components). Therefore, in such an embodiment, both the separator 6 and the cleaning device 7 may each comprise at least one grain loss sensor 17. However, it is also contemplated that either the separator 6 or the cleaning device 7 may comprise at least one grain loss sensor 17.

In one or some embodiments, the grain loss sensor(s) 17 are configured to detect the harvested material losses 16 only proportionally, since the grain loss sensors 17 may not be able to readily and directly detect the quantitatively exact amount of harvested material losses 16. This may not only be due to the fact that not all lost grains even reach the detection range of the grain loss sensors 17, but also because the correlation between the grain losses measured by the grain loss sensors 17 and the actual amount of lost grains may be very different.

The grain losses may be used to set, among other things, the working parameters of the various process-related working units of the combine harvester 2 so that the grain losses do not exceed the agrotechnical requirements, and the harvester 1 or combine harvester 2 may operate at maximum throughput. The grain losses may also be used to control other machine settings, such as the drive or the travel speed. Therefore, in the event of changing harvesting conditions, such as a change in crop density in an inhomogeneous field and the moisture of the harvested material, the working parameters and machine settings may be regularly adjusted on the basis of the sensed grain losses in order to improve or optimize the efficiency of the harvested material processing operation or the combine threshing process.

For a determination of the actually occurring harvested material losses 16 (e.g., the actual grain losses), so-called grain loss pans 18 may be placed on the ground or the agricultural area 12 which receive the crop flow discharged by the cleaning device 7 and the spreading device 10 proportionally in the form of the harvested material losses 16 and the harvested material mixture 13. Such a grain loss pan 18 may cover approximately the entire usable working unit width of the combine harvester 2. For this purpose, in one or some embodiments, one or two such grain loss pans 18 may be deposited next to each other on the ground or the agricultural area 12. The grain loss pan 18 may be deposited by a depositing device 19, which (as shown in FIG. 1) may be arranged or positioned on the underside of the combine harvester 2, or manually by a person. If a depositing device 19 is provided, it may be arranged or positioned transversely to the longitudinal axis or direction of travel of the combine harvester 2.

The combine harvester 2 may further comprise a driver assistance system 20, which may include a memory 26 for storing data or parameters, such as data and/or parameters relating to the combine harvester 2 and/or a harvested material processing operation or combine threshing process, a computing device (e.g., a processor 25) for processing data or parameters that are stored and/or may be stored in the memory 26, and an input/output unit 21, which may be used for interaction with the operator of the combine harvester 2. In one or some embodiments, the input/output unit 21 may comprise a touchscreen. The driver assistance system 20 may comprise a mobile terminal or may be designed as such that communicates with the combine harvester 2, such as wired and/or wirelessly via a receiver/transmitter module 22. Provided that the driver assistance system 20 comprises a mobile terminal, individual or all of the previously mentioned devices (e.g., the memory, the computing device and/or the input/output unit 21) may be part of the mobile terminal.

Thus, the driver assistance system 20 may comprise computational functionality, which may include at least one processor 25 and at least one memory 26 that stores information and/or software (such as execution of the grain loss sensor setting assistant 23), with the processor 25 configured to execute the software stored in the memory. In one or some embodiments, the at least one processor 25 may comprise a microprocessor, controller, PLA, or the like. The memory 26 may comprise any type of storage device (e.g., any type of memory). Though the processor 25 and the memory 26 are depicted as separate elements, they may be part of a single machine, which includes a microprocessor (or other type of controller) and a memory. Alternatively, the processor 25 may rely on memory unit 26 for all of its memory needs.

The processor 25 and memory 26 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

As mentioned previously, it may be important to establish a reference between the sensor values measured by the at least one grain loss sensor 17 of the separator 6 and/or the at least one grain loss sensor 17 of the cleaning device 7 and the actual grain losses in order to be able to perform a precise adjustment of the working parameters and machine settings of the combine harvester 2 and therefore to improve or optimize the efficiency of the harvested material processing operation or the combine threshing process. In order to establish such a reference, a so-called calibration of the grain loss sensors 17 may be performed. In one or some embodiments, the term “calibration of the grain loss sensors” may comprise a determination and/or an adjustment of a grain loss sensor sensitivity of the grain loss sensor(s) 17.

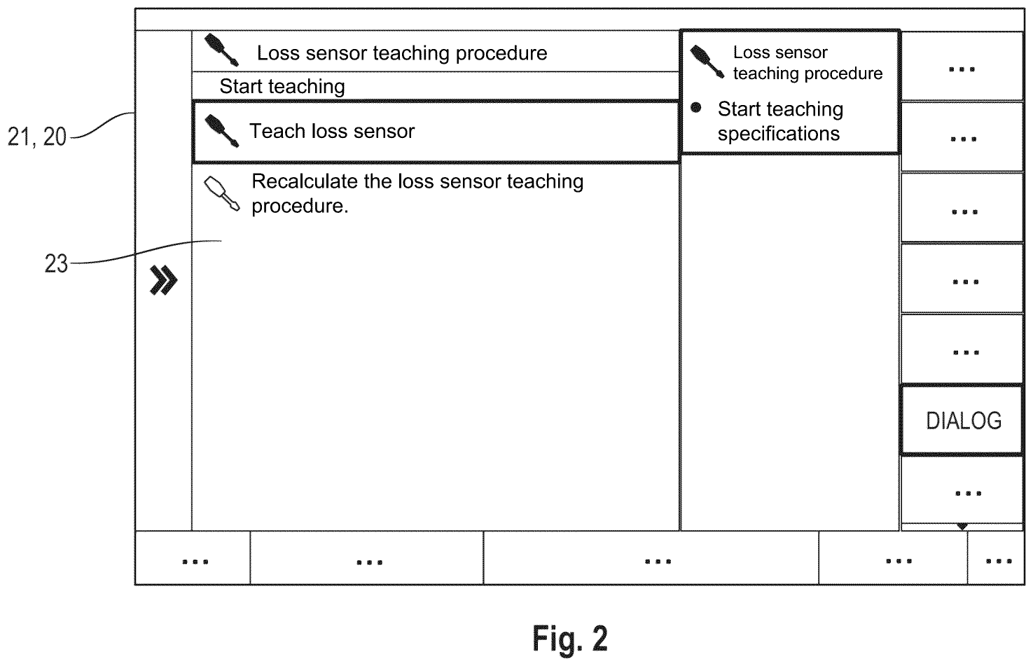

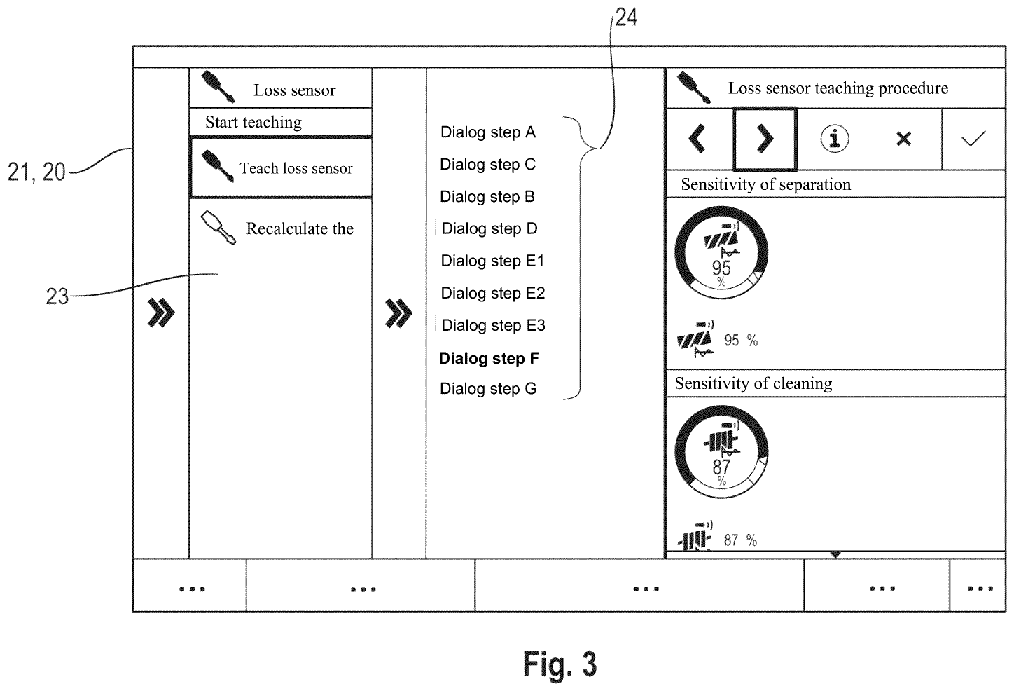

For determining and setting such a grain loss sensor sensitivity of the at least one grain loss sensor 17 of the separator 6 and/or the at least one grain loss sensor 17 of the cleaning device 7, the driver assistance system 20 may comprise a grain loss sensor setting assistant 23 (alternatively termed a grain loss sensor setting wizard). The grain loss sensor setting assistant 23 may comprise a software program executed on the driver assistance system 20. Such a grain loss sensor setting assistant 23 is illustrated in FIGS. 2 and 3 by way of example.

In one or some embodiments, the grain loss sensor setting assistant 23 is configured to determine, in a dialog with the operator in a plurality of dialog steps 24, the grain loss sensor sensitivity to be set for the at least one grain loss sensor 17 of the separator 6 and/or the at least one grain loss sensor 17 of the cleaning device 7, such as the grain loss sensor sensitivity to be set for the at least one grain loss sensor 17 of the separator 6 and the at least one grain loss sensor 17 of the cleaning device 7.

The grain loss sensor setting assistant 23 is configured to determine the grain loss sensor sensitivity of the at least one grain loss sensor 17 of the separator 6 and/or the at least one grain loss sensor 17 of the cleaning device 7 in the dialog taking into account retrievable and/or presettable data or parameters relating to the combine harvester 2 and/or the harvested material processing operation or combine threshing process. These data or parameters may be those which are stored in the memory 26 of the driver assistance system 20 and/or data or parameters which are input or preset by the operator via the input/output unit 21 and, if necessary, are stored at least temporarily in the memory 26 of the driver assistance system 20.

As previously discussed, the determination and adjustment of the grain loss sensor sensitivity of the grain loss sensors 17 may be performed using a dialog comprising one or a plurality of dialog steps 24. An illustration of the dialog, such as a dialog step 24 of the dialog, is shown by way of example in FIG. 3. The individual dialog steps 24 that are processed in the dialog are explained in detail below.

Accordingly, the dialog of the grain loss sensor setting assistant 23 may comprise a dialog step A in which the grain loss sensor setting assistant 23 checks whether operating states of the combine harvester 2 are required or necessary for determining and setting the grain loss sensor sensitivity of the grain loss sensors 17. As operating states of the combine harvester 2, the grain loss sensor setting assistant 23 may check whether the combine harvester 2 is in a harvested material processing operation or combine threshing process, and/or whether the harvested material processing operation or combine threshing process is being performed by the combine harvester 2 under stationary conditions. In one or some embodiments, further operating conditions of the combine harvester 2, the existence of which is checked in dialog step A, are not excluded. In this context, the term “stationary conditions” may mean essentially no (i.e., if at all negligible) fluctuations occur in the yield and/or throughput of the combine harvester 2 during the harvested material processing operation or combine threshing process, and/or that sensors do not deliver any values that lie outside specified limit values during the harvested material processing operation or combine threshing process.

In one or some embodiments, the check performed in dialog step A for the presence of required operating states of the combine harvester 2 is automatic. Alternatively, however, it is also contemplated that the operator is prompted in dialog step A to initiate this check. Insofar as it is determined during the check that the combine harvester 2 is not in the harvested material processing operation or combine threshing process and/or the harvested material processing operation or combine threshing by the combine harvester 2 is not occurring under stationary conditions, the grain loss sensor setting assistant 23 may output an instruction to the operator in dialog step A for the operator to control the combine harvester 2. This instruction may enable the operator to control the combine harvester 2 in such a way that the operating states of the combine harvester 2 required or necessary for determining and setting the grain loss sensor sensitivity are present (e.g., based on the operating state of the combine harvester 2, the grain loss sensor setting assistant 23 may determine and set the grain loss sensor sensitivity).

In one or some embodiments, the grain loss sensor setting assistant 23 dialog may include a dialog step B in which the operator enters a grain loss target to be achieved during the harvested material processing operation. This grain loss target may be entered, for example, as a relative amount based on a quantity, such as a total grain volume or a total grain mass (e.g., the grain loss sensor setting assistant 23 may output a request on the input/output unit requesting the operator to enter the grain loss target). In one or some embodiments, in dialog step B, the operator may enter a working width of the attachment 3 attached to the combine harvester 2. This input may be regarded as optional, since it is also possible for this quantity to be automatically determined by the grain loss sensor setting assistant 23 and may be regarded as given in dialog step B.

The grain loss sensor setting assistant 23 dialog may further include a dialog step C, in which the operator enters dimensions of the grain loss pan(s) 18. As described above, such a grain loss pan 18 may be used to determine actual grain losses. Since such grain loss pan 18 is generally rectangular in shape, the operator may enter a length and a width of the grain loss pan 18 in dialog step C (e.g., the grain loss sensor setting assistant 23 may output a request on the input/output unit requesting the operator to enter the length and the width of the grain loss pan(s) 18). Furthermore, in dialog step C, the operator may enter a deposit position for the grain loss pan 18 (e.g., a position in the area of the rear of the combine harvester 2 at which the grain loss pan 18 is to be deposited). It is also contemplated to enter more than one deposit position, such as two deposit positions, if more than one grain loss pan 18 is to be used to determine the actual grain losses.

The dialog of the grain loss sensor setting assistant 23 may further include a dialog step D, in which the operator is instructed to initiate the deposit of the grain loss pan(s) 18. Basically, there may be two different ways to initiate the deposit of the grain loss pan 18. Provided that a depositing device 19 for depositing the grain loss pan 18 is provided in the combine harvester 2, the operator may initiate the automatic deposition of the grain loss pan 18 on the ground or agricultural area 12 via the depositing device 19, for example by pressing an actuating element. If such a depositing device 19 is not provided on the combine harvester 2, but instead the grain loss pan 18 is deposited manually, the operator of the combine harvester 2 may instruct another person to deposit or place the grain loss pan 18 on the ground or agricultural area 12.

In dialog step D, the operator may further trigger a measurement for determining grain losses of the separator 6 and/or the cleaning device 7 as well as optionally (e.g. if there is a sensor for determining a yield of the combine harvester 2) a measurement for determining the yield of the combine harvester 2. By the operator triggering this measurement in dialog step D, a sensor value of the at least one grain loss sensor 17 of the separator 6 and/or a sensor value of the at least one grain loss sensor 17 of the cleaning device 7 and/or a sensor value of the sensor for determining the yield of the combine harvester 2 may be determined over a fixed measurement period T, such as between 10 and 30 seconds (e.g., 20 seconds).

In dialog step D, the operator may also receive an instruction (e.g., via the input/output unit 21) to trigger or initiate the measurement for determining grain losses of the at least one grain loss sensor of the separator 6 and/or the cleaning device 7 and/or the measurement for determining the yield of the combine harvester 2 substantially at the same time (e.g., at the same time or at least immediately following one another) as the grain loss pan 18 is deposited, so that the determination of grain losses as well as optionally the yield takes place substantially at the same location as the grain loss pan 18 is deposited. This may ensure that the sensors detect substantially the same part of the harvested material mixture 13 that is also collected by the grain loss pan 18.

Provided that a mobile terminal is used for the determination and adjustment of the grain loss sensor sensitivity, in dialog step D, the position of the combine harvester 2 during the measurement of the sensor values and the deposition of the grain loss pan 18 may be recorded and transmitted, such as via the receiver/transmitter module 22, to the mobile terminal.

If there is no sensor on the combine harvester 2 for determining the yield of the combine harvester 2, a yield of the combine harvester 2 may be estimated by the operator and entered in the dialog, such as in dialog step B, so that the entry of the yield of the combine harvester 2 may be available as another or alternative option in dialog step B in such a case.

The grain loss sensor setting assistant 23 dialog may include a dialog step E, which in turn may include a number of individual dialog steps E1 through E3. The dialog step E may include a dialog step E1 in which the operator selects a metric for inputting a quantity of loss grains determined using the grain loss sensor 17 (e.g., the grain loss sensor setting assistant 23 generates an output on input/output unit 21 that lists a plurality of metrics for the operator to choose from). Such a metric may be either a number of determined loss grains, a mass of determined loss grains, or a volume of determined loss grains. After selecting the metric, the operator may enter, in dialog step E2, the amount of determined loss grains using the grain loss pan 18 according to the previously selected metric (e.g., the grain loss sensor setting assistant 23 generates an output on input/output unit 21 that requests input from the operator to input the amount of determined loss grains). After the number of loss grains has been entered by the operator in dialog step E2, a determined actual grain loss may be displayed to the operator in a dialog step E3 (e.g., the grain loss sensor setting assistant 23 generates an output on input/output unit 21 indicative to the operator of the determined actual grain loss). This actual grain loss may also be displayed as a relative amount related to a quantity, for example a total grain volume or a total grain mass. In order to calculate the actual grain loss, the grain loss sensor setting assistant 23 may makes use any one, any combination, or all of: the entered number (or amount) of loss grains; the yield determined in the course of the measurement in dialog step D; the dimensions of the grain loss pan 18 entered in dialog step B; or the retrieved or entered working width of the attachment 3. However, the operations to be processed in dialog steps E1 to E3 may also be processed in one dialog step (e.g., dialog step E).

The dialog of the grain loss sensor setting assistant 23 may comprise a dialog step F, an example of which is illustrated in FIG. 3, in which the determined grain loss sensor sensitivity for the at least one grain loss sensor 17 of the separator 6 and/or for the at least one grain loss sensor 17 of the cleaning device 7 is displayed to the operator. For determining the grain loss sensor sensitivity displayed to the operator, the grain loss sensor setting assistant 23 may make use of the data or parameters determined in the dialog steps A to E and/or entered by the operator. Dialog step F may further offer the operator the possibility of subsequently adjusting the determined grain loss sensor sensitivity of the at least one grain loss sensor 17 of the separator 6 and/or of the at least one grain loss sensor 17 of the cleaning device 7 displayed to him/her in accordance with his/her ideas and empirical values and deviating from the determined suggestion. This may provide the operator with the possibility to manually manipulate or override the grain loss sensor sensitivity determined during the dialog with the grain loss sensor setting assistant 23.

The dialog of the grain loss sensor setting assistant 23 may further include a dialog step G, in which the operator may confirm or reject the grain loss sensor sensitivity displayed to him/her (e.g., the grain loss sensor setting assistant 23 generates an output on input/output unit 21 that indicates the grain loss sensor sensitivity and requests the operator to accept or reject) and, if applicable, adjusted. Provided that the operator confirms or accepts the grain loss sensor sensitivity displayed to him/her and adapted if necessary, this may be automatically adopted or set for the at least one grain loss sensor 17 of the separator 6 and/or the at least one grain loss sensor 17 of the cleaning device 7. Accordingly, the operator no longer has to manually adjust or set the sensor sensitivity of the corresponding grain loss sensor 17 in a process step following the dialog. If the operator rejects the grain loss sensor sensitivity displayed to him/her, the dialog for determining and setting the grain loss sensor sensitivity is terminated.

The previously described dialog steps 24 are not to be understood as restrictive with respect to additional dialog steps in the dialog. Additional dialog steps may be provided before, between and/or after the individual dialog steps 24 described above. Furthermore, the naming of the previously described dialog steps 24 with the letters “A to G” is not to be understood as meaning that these dialog steps are processed one after the other according to the letter sequence. Rather, naming by means of letters merely serves to distinguish the individual dialog steps from one another. For example, dialog step C may also take place before dialog step B, as may be seen in FIG. 3, for example. The dialog steps may be realized or manifested in diverse ways. A dialog step may also comprise several dialog steps, other dialog steps may be processed between the individual dialog steps of a dialog step, and some dialog steps may also be processed several times if this is necessary.

As discussed above, the data or parameters and/or instructions that may be entered by and/or displayed to the operator in the several dialog steps 24 may be entered and/or displayed via the input/output unit 21 of the driver assistance system 20, as illustrated particular in FIGS. 2 and 3. Any calculations taking place during the dialog of the grain loss sensor setting assistant 23 may be performed by the computing device of the driver assistance system 20.

After an initial calibration of the at least one grain loss sensor 17 of the separator 6 and/or the at least one grain loss sensor 17 of the cleaning device 7, the deposition of a grain loss pan 18 and its evaluation may be dispensed with during recalibration.

In addition to the previously described combine harvester 2 and the driver assistance system 20 with the grain loss sensor setting assistant 23 for use in such a combine harvester 2, a method for determining and adjusting a grain loss sensor sensitivity of at least one grain loss sensor 17 of such a combine harvester 2 is also disclosed. The method may accordingly be characterized in that the grain loss sensor sensitivity to be set for the at least one grain loss sensor 17 of the separator 6 and/or the at least one grain loss sensor 17 of the cleaning device 7 is determined by using the grain loss sensor setting assistant 23 of the driver assistance system 20 of the combine harvester 2 in a dialog with the operator in a plurality of dialog steps 24. All features or dialog steps 24 described in the context of the combine harvester 2 and/or the driver assistance system 20 are equally applicable to this method. In this regard, the grain loss sensor setting assistant 23 may be configured to perform one or more operations regarding the grain loss, such as any one, any combination, or all of: determining and/or setting a grain loss sensor sensitivity of the at least one grain loss sensor of the separator and/or the at least one grain loss sensor of the cleaning device; inputting one or more parameters via dialog step(s) with regard to grain loss; or enabling an operator to approve and/or to adjust one or more metrics regarding grain loss (e.g., the grain loss sensor sensitivity); etc. Further, the present disclosure includes one or more dialog steps. The dialog steps may be performed in any order, such as using any one, any combination, or all of: dialog step A; dialog step B; dialog step C; dialog step D; dialog step E (including any one, any combination, or all of dialog steps E1, E2, or E3); dialog step F; or dialog step G.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Harvesting machine
2 Combine harvester
3 Attachment
4 Inclined conveyor
Threshing device
6 Separator
7 Cleaning device
8 Transport device
9 Grain tank
10 Distribution device
11 Harvested material flow
12 Ground or agricultural area
13 Harvested material mixture
14 Straw chopper
15 Power spreader
16 Harvested material loss
17 Grain loss sensor
18 Grain loss pan
19 Depositing device
20 Driver assistance system
21 Input/output unit
22 Receiver/transmitter module
23 Grain loss sensor setting assistant
24 Dialog step
25 Processor
26 Memory

1. A combine harvester comprising:
a plurality of working units configured to perform one or more harvested material processing operations, wherein the plurality of working units comprise at least one separator and at least one cleaning device, wherein one or both of the at least one separator or the at least one cleaning device comprises at least one grain loss sensor; and
a driver assistance system comprising a grain loss sensor setting assistant configured to:
determine and adjust a grain loss sensor sensitivity of the at least one grain loss sensor of the one or both of the at least one separator or the at least one cleaning device; and
determine, in a dialog with an operator in one or more dialog steps, the grain loss sensor sensitivity to be set for the at least one grain loss sensor of the one or both of the at least one separator or the at least one cleaning device.

2. The combine harvester of claim 1, wherein the grain loss sensor setting assistant is configured to determine the grain loss sensor sensitivity in the one or more dialog steps by accounting for one or both of retrievable or presettable data relating to one or both of the combine harvester or a harvested material processing operation.

3. The combine harvester of claim 1, wherein the one or more dialog steps of the grain loss sensor setting assistant comprises a dialog step A in which the grain loss sensor setting assistant is configured to check whether the combine harvester is operating in one or more predetermined operating states in order to determine and set the grain loss sensor sensitivity.

4. The combine harvester of claim 3, wherein, in the dialog step A, the grain loss sensor setting assistant is configured to check whether one or both of the combine harvester is in a harvested material processing operation or the harvested material processing operation is being performed by the combine harvester under stationary conditions.

5. The combine harvester of claim 4, wherein, in the dialog step A, responsive to the grain loss sensor setting assistant determining of one or both of the combine harvester is not in the harvested material processing operation or the harvested material processing operation by the combine harvester is not under stationary conditions, the grain loss sensor setting assistant is configured to generate an instruction to the operator to control the combine harvester.

6. The combine harvester of claim 3, wherein the one or more dialog steps of the grain loss sensor setting assistant comprises a dialog step B in which the operator enters one or more of: a grain loss target to be achieved during a harvested material processing operation; a working width of an attachment mounted on the combine harvester; or a yield of the combine harvester.

7. The combine harvester of claim 6, wherein the one or more dialog steps of the grain loss sensor setting assistant comprises a dialog step C in which the operator enters one or both of dimensions of a grain loss pan or a placement position of the grain loss pan.

8. The combine harvester of claim 7, wherein the one or more dialog steps of the grain loss sensor setting assistant comprises a dialog step D in which the operator receives an instruction to initiate a deposit of the grain loss pan.

9. The combine harvester of claim 8, wherein, in the dialog step D, the grain loss sensor setting assistant is configured to receive a trigger from the operator for a measurement to determine one or more of: grain losses of the separator; grain losses of the cleaning device; or a yield of the combine harvester; and
wherein a sensor value of one or both of the at least one grain loss sensor of one or both of the separator or the cleaning device or of a sensor for determining the yield of the combine harvester is determined over a specified measuring period.

10. The combine harvester of claim 9, wherein, in dialog step D, the grain loss sensor setting assistant is configured to instruct the operator to trigger a measurement to determine the grain losses of one or both of the separator or the cleaning device and the yield of the combine harvester substantially at a same location at which the grain loss pan is deposited.

11. The combine harvester of claim 8, wherein the dialog of the grain loss sensor setting assistant comprises at least one dialog step E in which: the operator selects a metric for inputting an amount of loss grains determined using the grain loss pan; the operator inputs a determined amount of loss grains; and actual grain losses are displayed to the operator.

12. The combine harvester of claim 1, wherein the dialog of the grain loss sensor setting assistant comprises a dialog step F in which:
the grain loss sensor sensitivity of the one or both of the at least one separator or the at least one cleaning device is displayed to the operator; and
the operator adjusts the grain loss sensor sensitivity displayed.

13. The combine harvester of claim 12, wherein the dialog of the grain loss sensor setting assistant comprises a dialog step G, in which the operator confirms the grain loss sensor sensitivity displayed; or
wherein the operator adjusts or rejects the grain loss sensor sensitivity of the one or both of the at least one separator or the at least one cleaning device.

14. A method for determining and adjusting a grain loss sensor sensitivity of at least one grain loss sensor of a combine harvester, the method comprising:
operating the combine harvester, wherein the combine harvester comprises at least one separator and at least one cleaning device for performing at least one harvested material processing operation, wherein one or both of the at least one separator or the at least one cleaning device comprises at least one grain loss sensor, wherein the combine harvester comprises a driver assistance system;
determining and adjusting, using a grain loss sensor setting assistant of the driver assistance system, a grain loss sensor sensitivity of the at least one grain loss sensor of the one or both of the at least one separator or the at least one cleaning device; and
determining, in a dialog with an operator in one or more dialog steps, the grain loss sensor sensitivity to be set for the at least one grain loss sensor of the one or both of the at least one separator or the at least one cleaning device.

15. The method of claim 14, wherein the grain loss sensor setting assistant determines the grain loss sensor sensitivity in the one or more dialog steps by accounting for one or both of retrievable or presettable data relating to one or both of the combine harvester or a harvested material processing operation.

16. The method of claim 14, wherein the one or more dialog steps of the grain loss sensor setting assistant comprises a dialog step A in which the grain loss sensor setting assistant is configured to check whether the combine harvester is operating in one or more predetermined operating states in order to determine and set the grain loss sensor sensitivity.

17. The method of claim 16, wherein, in the dialog step A, the grain loss sensor setting assistant checks whether one or both of the combine harvester is in a harvested material processing operation or the harvested material processing operation is being performed by the combine harvester under stationary conditions.

18. The method of claim 17, wherein, in the dialog step A, responsive to the grain loss sensor setting assistant determining of one or both of the combine harvester is not in the harvested material processing operation or the harvested material processing operation by the combine harvester is not under stationary conditions, the grain loss sensor setting assistant generates an instruction to the operator to control the combine harvester.

19. The method of claim 16, wherein the one or more dialog steps of the grain loss sensor setting assistant comprises a dialog step B in which the operator enters one or more of: a grain loss target to be achieved during a harvested material processing operation; a working width of an attachment mounted on the combine harvester; or a yield of the combine harvester.

20. The method of claim 19, wherein the one or more dialog steps of the grain loss sensor setting assistant comprises a dialog step C in which the operator enters one or both of dimensions of a grain loss pan or a placement position of the grain loss pan.
